(19) United States
(12) Patent Application Publication
(10) Pub. No.: US 2026/0227964 A1
(43) Pub. Date: Aug. 6, 2026

(54) System and method to dynamically modify specific code portions of an application

(71) Applicant: Bank of America Corporation, Charlotte, NC (US)

(72) Inventors: Varshini RV, Chennai (IN); Madhav Vaidyanath, Chennai (IN); Amit Mishra, Chennai (IN); Thilagaraj Kannaiyan, Chennai (IN); S.B. PRAVIN KUMAR, Chennai (IN)

(21) Appl. No.: 19/047,346

(22) Filed: Feb. 6, 2025

(51) Int. Cl. G06F 8/35; G06F 11/34

(52) U.S. Cl. CPC G06F 8/35; G06F 11/3495

(57) ABSTRACT

An apparatus comprises a memory communicatively coupled to a processor. The processor may be configured to train multiple artificial intelligence algorithms based at least in part upon input data representative of historical usage data of an application and, using the trained artificial intelligence algorithms, associate a interaction type in the application with a segment of user devices of a user device group, electronically divide a base code of the application into multiple code blocks, correlate an impact of a code block to the portion of the application, electronically extract the code block from the code blocks, determine a modification to the code block based at least in part upon the interaction type, modify the code block to include the first modification and release an updated version of the base code as a new release version of the application to the segment of user devices of the user device group.

### TECHNICAL FIELD

The present disclosure relates generally to operations associated with dynamically modifying base code of an application, and more specifically to a system and method to dynamically modify specific code portions of the application.

### BACKGROUND

In today's digital landscape, new versions of applications are broadly released to an entire customer base. This approach causes user-preferences to be overlooked whenever new improvements are considered for the code base of the application. Further, all code base associated with an application is required to be modified at once, which causes applications to be completely offline if an error occurs while adding new features to the code base. In some cases, in an attempt to update the code base of a given application, the entire code base may be corrupted, causing the delisting of the application from customer-facing interfaces (e.g., application stores).

### SUMMARY OF THE DISCLOSURE

In one or more embodiments, a system and method described herein are configured to dynamically modify specific portions in the code base of an application. In particular, the system may be configured to create a unique version of an application for a specific user segment of an entire customer base. In particular, the system is configured to use generative artificial intelligence (AI) to determine a portion of the application to optimize based on user historical data patterns within the application and trigger creation of an updated version of the application that includes said optimization. Herein, user patterns are tracked for multiple users to determine a portion of the application to optimize for a specific user segment of the entire customer base. Once the portion of the application is determined, the system is configured to create the unique version of the application including code that optimizes usage of the determined portion of the application and release this unique version of the application to user devices associated with the specific user segment. Further, the system is configured to modify individual portions of the application code to optimize usage and/or performance of the specific portion of the application. In this regard, the system is configured to train one or more AI models to process base code and code documentation related to the application using natural language (e.g., plain English). Herein, changes and/or modifications to the application code may be triggered and performed using instructions in plain English. In some embodiments, the system may be configured to determine portions of the application to modify, use the AI model trained on all code and code documents of the application to trigger and/or perform changes to individual portions of the application code that optimize individual portions of the application using natural language commands.

In some embodiments, system is configured to evaluate performance of specific versions of an application. In particular, the system configured to use generative AI to release multiple unique versions of an application to the specific user segment of the entire customer base, evaluate usage and/or performance of the specific portion of the application as users in the segment interact with each version, and select one version of the application for permanent use. Herein, many unique application versions may be generated. The unique versions may comprise different optimizations for a same portion of the application.

In conventional systems, updating code base of applications involves withdrawing the application from an application marketplace where the application is not allowed for use and evaluating needs for global changes in the application. These global changes may include interface modifications, general adaptability of the code base to be used in updated operating systems of host user devices, and/or removal of defective and/or conflicted code lines (e.g., bugs in the code). The approach followed by conventional systems does not account for user preferences and/or the device capabilities of specific users. In this regard, conventional systems fail to modify code base for applications in a way that optimizes operations favored by specific users and/or facilitated by specific user devices. Furthermore, conventional systems require lengthy review process in which any change to the code base is scrutinized and evaluated for possible adverse impacts. This approach requires several layers of approval before code base of an application is given approval to be modified because different departments in an organization are required to present and defend changes to the application before a specific change is adopted.

In one or more embodiments, the systems and methods described herein are integrated into practical applications that overcome many of the deficiencies described above in reference to conventional systems. In particular, the systems described herein are integrated into the practical applications of: 1) providing dynamic modifications to code base of applications targeted to specific users and/or capabilities of specific user devices; 2) accelerating implementation of changes in code base of applications; and 3) increasing speeds in which code base itself is modified for an application. Accordingly, the systems and methods described herein address problems that are specific to software integration in telecommunication devices, the Internet, and the underlying computer systems that support those technologies.

With respect to 1), the systems and methods described herein are integrated into a practical application of providing dynamic modifications to code base of applications targeted to specific users and/or capabilities of specific user devices in a user device group. Contrary to conventional systems that require global changes to base code of applications, the system provides targeted versions of the application to a specific segment of the user device group (e.g., one or more specific users and/or user devices). In conventional systems, global changes are released to every user device hosting the newest version of an application.

Herein, the system is configured to release new versions of an application that include base code modifications that improve user experience for specific users. Further, the system is configured to release versions of an application that include base code modifications that optimize performance of the application in specific user devices. In some embodiments, all other application versions used by the rest of a user device group are kept in a global release version, while specific changes to the base code of the application are made to improve specific user experiences and/or specific user device performances. To this end, the system is configured to determine different optimizations to the base code of the application for different individual user devices and/or segments of the user device group. The optimizations may be targeted based on feedback collected from the individual user devices in a given segment. In this approach, processing speeds in the individual user devices are improved as user devices prioritize performance of only preferred operations. Further, memory usage is reduced in the individual user devices as user devices are not required to cache unnecessary information that is less relevant to the needs of the specific segment of user devices.

For example, two user devices in a user device group may be identical (e.g., comprise same communication capabilities) and host a same application (e.g., with a same base code). The application may enable data exchanges within a private network (e.g., a local network using short-range wireless communications) or a public network (e.g., using long-range wireless communications). In the user device group, a first user device may perform a majority of data exchange operations using the private network over the public network while a second user device may perform a majority of data exchange operations using the public network over the private network. In this example, while the conditions surrounding all user devices are the same, the specific usage of the application in these user devices is different. Herein, the system may be configured to determine different usages of the application for the two different devices based on feedback collected from the user devices. Then, the system may be configured to generate code modifications to specific portions of the base code in which device performance is improved. In this example, the code modifications for the first user device may prioritize short-range connectivity and the code modifications for the second user device may improve robustness of long-range connectivity. The system may modify the base code of the application separately for each of the user devices to create two new versions of the application. Upon confirming that these new versions are ready for release, the system may be configured to release one version to the first user device and the other version to the second user device. After the implementation of the system, each device may be equipped with an updated version of the application that is targeted to the needs of specific user devices. As a result, while these updated versions of the applications may comprise a same source code, these updated versions may be different from one another because the base code is modified differently for each of them.

In the aforementioned example, from the perspective of the user devices, device performance is improved, and reliable usage of the application is increased. Using conventional systems, the base code of the application cannot be modified for only one of the user devices in the example. Instead, both devices would need to remain unoptimized and/or sub-optimized using conventional systems that require global versions of an application across all host devices.

With respect to 2) and 3), the systems and methods described herein are integrated into a practical application of accelerating implementation of changes in code base of applications. Contrary to conventional systems that require lengthy weighting processes before an updated version of an application is released, the system provides an accelerated approach for incorporating changes to a code base during a production stage by dynamically pre-weighting possible impacts of changes in specific portions of the code base in new releases of the application. In a weighting process, several hours of processing may be used to electronically calculate a net positive or a net negative impact of any possible change to the base code. The net impacts are weighted against the need to make a specific change to the base code. At this stage, possible changes may be dropped or accepted based on result from the weighting process. The weighting process may be performed during a production stage where the application is unavailable to user devices. This lengthy weighting process may cause new features to be delayed, operations in the applications to be halted, and/or data migration issues between application releases if the weighting process is not done properly.

Herein, the system is configured to collect feedback interactions from users of an application and determine portions of an application to optimize based on an analysis of the feedback interactions. These optimizations are pre-weighted for production to be included in an updated version of the application. In particular, the system evaluates impacts of changes in the base code of the application prior to considering the possible changes for implementation. At this stage, the system is configured to modify individual portions of the code base to achieve the specific optimizations. These changes to the code base are done precisely to avoid adverse impacts associated with modifying large portions of the code base (e.g., application downtime, freezing, slowdowns, and the like). Given that the optimizations are pre-weighted, by the time the application enters a production stage, the changes are ready for implementation and lengthy weighting operations are bypassed without having to wait for additional approval from production management and/or overriding commands.

Technical problems caused by user devices running sub-optimized versions of applications or upgrading applications using conventional systems include: 1) application freezing or downtime caused by overprocessing of unnecessary operations and/or over caching of unnecessary information; 2) application integration failures caused by integration design weaknesses; and 3) application integration failures caused by integration infrastructure issues. In one or more embodiments, the systems and methods described herein are directed to improvements in these areas of application modernization. Specifically, the system is configured to increase the robustness of underlying computer systems by seamlessly modernizing applications between legacy and new releases and inhibiting and/or eliminating issues caused by changes in user device capabilities and/or application scalability.

With regards to 1), by removing processing of unnecessary operations and/or caching of unnecessary information, the system improves processor speeds and memory usage in user devices using new releases of the application. Unnecessary operations are removed as new releases are optimized to prioritize certain operations over others in the application. Caching of unnecessary information is inhibited and/or eliminated as new releases are optimized to remove datasets that are not regularly used in the user device. Herein, the system is configured to release operational and memory bandwidth in the user devices with each new release of the application.

With regards to 2), the systems inhibit and/or eliminate integration design weaknesses by limiting adverse impacts caused by personal biases and/or tool limitations used to optimize base code portions of an application. Herein, the systems are configured to rely on feedback collected from users and/or user devices to inform areas of improvement and/or optimization in the application. As the application is updated specifically to meet operational capability and/or demand for a specific user device, new releases of the application are less likely to experience design flaws. By maintaining consistency in the design of the application for specific users, the user experience is likely to improve as user preferences and usage patterns lead to feedback that the systems use to create additional new releases of the application over time.

With regards to 3), the systems inhibit and/or eliminate integration infrastructure failures by limiting adverse impacts caused by data migration issues and/or compatibility conflicts between legacy versions and updated release versions of the application. It is common for conventional systems to suffer from corrupted datasets when transforming base code to adapt to new operating systems and/or new device capabilities because the conventional system lacks information beyond the content of the base code. Herein, the system trains an artificial intelligence algorithm to understand for all documentation associated with a source code and lifetime changes to the application. Then, the trained artificial intelligence algorithm is used to evaluate current user device feedback and modify the code base to optimize application usage and device performance. By considering all (successful and failed) communications, documentations, and versions of the application, the system is configured to modify the base code while reducing the possibility of conflicts in datasets, databases, and/or communication links created in previous releases of the application.

Further, in relation to 2) and 3), the adverse impact of application integration problems on organizations is significant and far-reaching. Integration challenges often do not arise from a single issue, but from a combination of factors. Commonly, these factors include system integration issues, technological issues, and insufficient planning. In one or more embodiments, the system disclosed herein implements controls and contingency measures to reduce the likelihood integration failures and mitigate software integration challenges.

In one or more embodiments, the systems and the methods may be performed by an apparatus, such as a server. Further, the system may be a data exchange system, which comprises the apparatus. In addition, the system and the method may be performed as part of a process performed by the apparatus. As a non-limiting example, the apparatus may comprise a memory and a processor communicatively coupled to one another. The memory may be operable to store one or more artificial intelligence algorithms configured to evaluate data.

The processor may be configured to train a first artificial intelligence algorithm based at least in part upon first input data representative of historical usage data of an application. The historical usage data may comprise usage patterns associated with a portion of the application. Further, the processor may be configured to, using the trained first artificial intelligence algorithm, create multiple tracking parameters configured to track performance of the portion of the application, track, in conjunction with the plurality of tracking parameters, multiple interactions between a user device group and the portion of the application, structure the interactions into one or more interaction types, and associate an interaction type of the one or more interaction types with a segment of user devices of the user device group.

The processor may be configured to train a second artificial intelligence algorithm based at least in part upon second input data representative of documentation associated with base code of the application. The documentation may comprise compilation reports associated with previous updates of the application and the base code. The base code may be representative of a current release version of the application. The processor may be configured to, using the trained second artificial intelligence algorithm, electronically divide the base code into multiple code blocks based at least in part upon a corresponding impact of each code block in the base code of the application, correlate an impact of a code block to the portion of the application, electronically extract the code block from the plurality of code blocks, and determine a modification to the code block based at least in part upon the interaction type of the one or more interaction types and the impact of the code block to the portion of the application. The modification to the code block being configured to prioritize performance of the interaction type when performed in the portion of the application.

In addition, the processor may be configured to, using the trained second artificial intelligence algorithm, modify the code block to include the modification, compile a modified version of the code block, and incorporate the modified version of the code block back into an updated version of the base code in response to compiling the modified version of the code block. Further, the processor may be configured to, using the trained first artificial intelligence algorithm, release the updated version of the base code as a new release version of the application to the segment of user devices of the user device group. The new release version of the application may be configured to prioritize performance of the interaction type when performed in the portion of the application by the segment of user devices of the user device group.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrate an example flowchart of a method to dynamically modify specific code portions of an application performed by the system of FIG. 1 in accordance with one or more embodiments; and

FIGS. 3A and 3B illustrate an example flowchart of a method to implement the operational flow of FIG. 2 in accordance with one or more embodiments.

### DETAILED DESCRIPTION

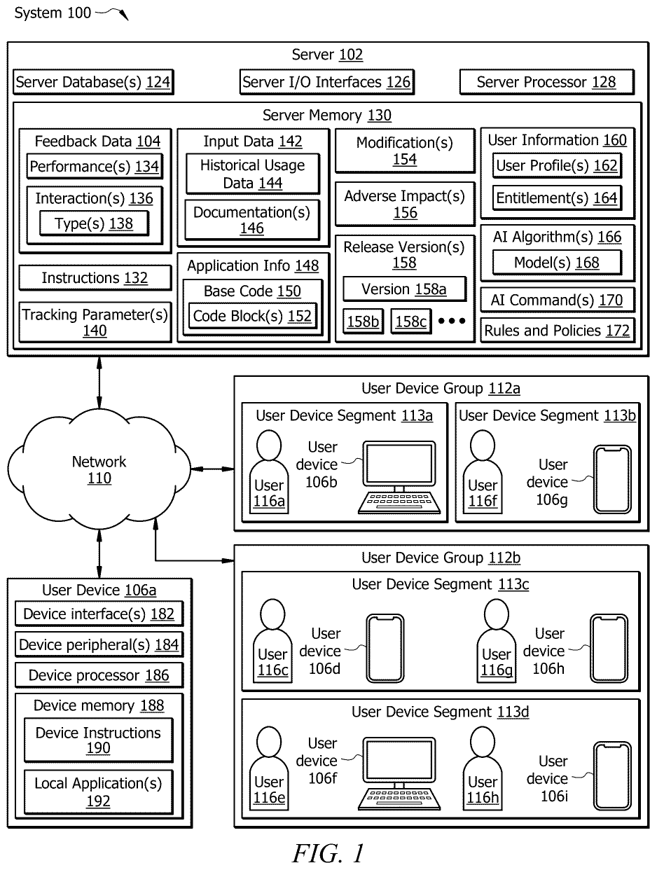

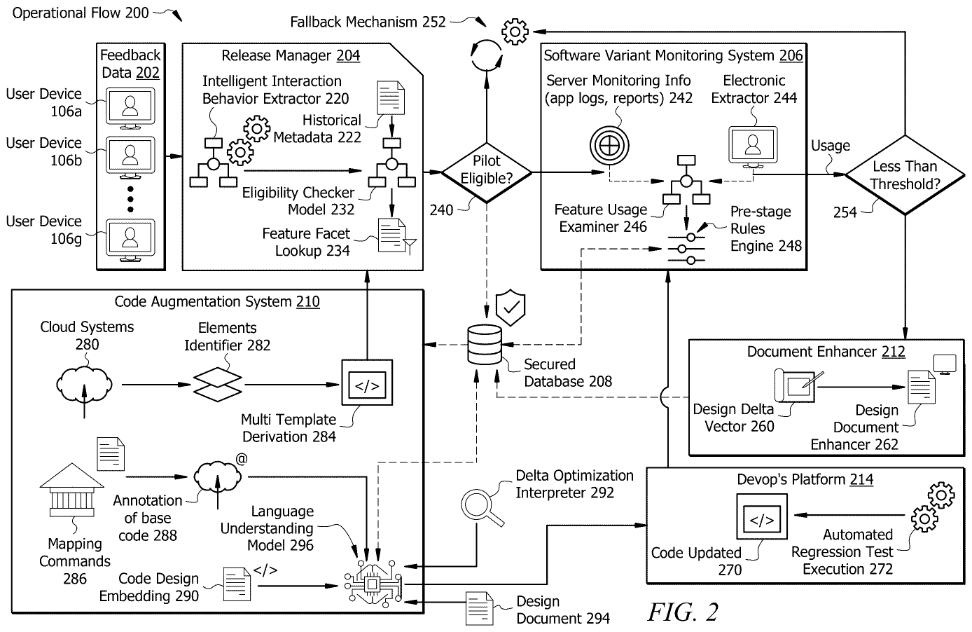

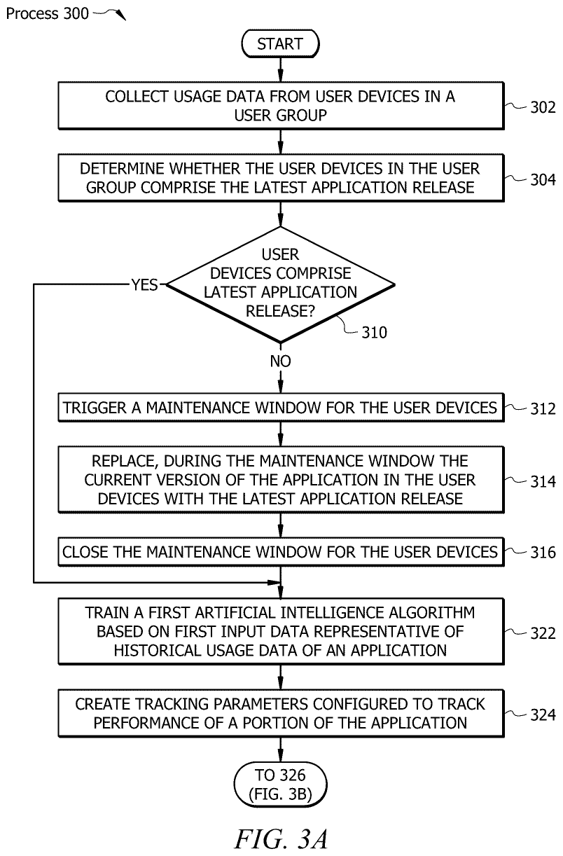

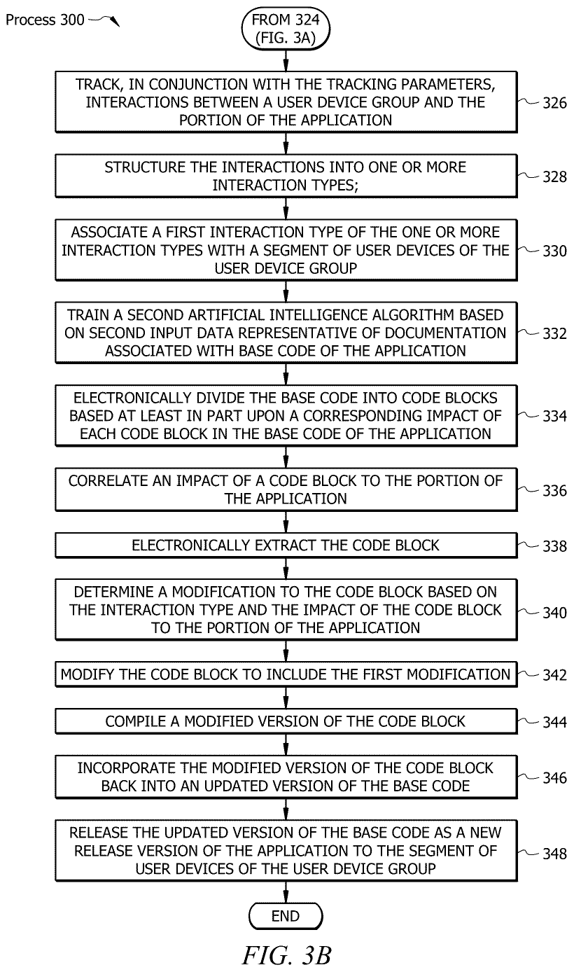

As described above, this disclosure provides various systems and methods to dynamically modify specific code portions of an application. FIG. 1 illustrates a system 100 in which a server 102 is configured to determine specific optimizations for an application based on specific collected device feedback. FIG. 2 illustrates an operational flow 200 performed by the system 100 of FIG. 1. FIGS. 3A and 3B illustrate a process 300 performed to implement the operational flow 200 of FIG. 2.

### System Overview

FIG. 1 illustrates an example system 100, in accordance with one or more embodiments. The system 100 may comprise a server 102 configured to configured to analyze feedback data 104 received from a communication network. The system 100 includes a server 102 communicatively coupled to a user device 106a, a user device 106b, a user device 106c, a user device 106d, a user device 106e, a user device 106f, a user device 106g, a user device 106h, and a user device 106i (collectively, user devices 106) via a network 110. The user devices 106 may be user nodes configured to trigger exchanges of data and/or perform one or more communication operations 108 with the server 102 via the network 110. The user devices 106 may be working nodes configured to receive instructions to perform one or more communication operations 108 based on instructions received from the server 102. In some embodiments, some of the user devices 106 may be clustered together in one or more user device groups 112. Further, the user devices 106 may be divided into segments 113. Each of the user devices 106 may be associated with one or more corresponding operators. These operators are shown as a user 116a, a user 116b, a user 116c, a user 116d, a user 116e, a user 116 f, a user 116g, and a user 116 h (collectively, users 116) in the user device groups 112.

In FIG. 1, a user device group 112a comprises a user device segment 113a and a user device segment 113b. The user device group 112a is shown comprising the user 116a associated with the user device 106b in the user device segment 113a and the user 116f associated with the user device 106g in the user device segment 113b. Further, a user device group 112b comprises a user device segment 113c and a user device segment 113d. The user device group 112c is shown comprising the user 116c associated with the user device 106d and the user 116g associated with the user device 106 h in the user device segment 113 c, and the user 116e associated with the user device 106f and the user 116h associated with the user device 106i in the user device segment 113d.

In one or more embodiments, the server 102 may comprise one or more server databases 124, one or more server input (I)/output (O) interfaces 126, at least one server processor 128, and at least one server memory 130 communicatively coupled to one another. In some embodiments, the server memory 130 may comprise instructions 132, the feedback data 104 comprising one or more user devices performances 134 and one or more interactions 136 associated to one or more interaction types 138, one or more tracking parameters 140, input data 142 comprising historical usage data 144 and one or more documentations 146, application information 148 comprising at least one base code 150 with multiple code blocks 152 and multiple application portions 153, one or more modifications 154, one or more impacts 156 of the one or more code blocks 152 in the base code 150, one or more release versions 158 (shown as a version 158a, a version 158b, and a version 158c among others), user information 160 comprising one or more user profiles 162 associated with one or more entitlements 164 to access one or more services (e.g., applications) in a communication network (e.g., the network 110), one or more artificial intelligence (AI) algorithms 166 configured to create one or more models 168 through training operations, one or more AI commands 170, and one or more rules and policies 172.

Referring to the user device 106a a non-limiting example, the user device 106a may comprise one or more device interfaces 182, one or more device peripherals 184, at least one device processor 186, and at least one device memory 188 communicatively coupled to one another. The device memory 188 may comprise device instructions 190 and/or one or more local applications 192.

### System Components

### Server

The server 102 is generally any device or apparatus that is configured to process data and communicate with computing devices (e.g., the user devices 106), additional databases, systems, and the like, via the one or more server I/O interfaces 126 (i.e., a user interface or a network interface). The server 102 may comprise the server processor 128 that is generally configured to oversee operations of the processing engine. The operations of the processing engine are described further below in conjunction with the system 100 described in FIG. 1, the operational flow 200 in FIG. 2, and the process 300 described in FIGS. 3A and 3B.

The server 102 comprises multiple server databases 124 configured to provide one or more memory resources to the server 102 and/or the user devices 106. The server 102 comprises the server processor 128 communicatively coupled with the server databases 124, the server I/O interfaces 126, and the server memory 130. The server 102 may be configured as shown, or in any other configuration. In one or more embodiments, the server databases 124 are configured to store data that enables the server 102 to configure, manage and coordinate one or more middleware systems. In some embodiments, the server databases 124 store data used by the server 102 to function as a halfway point in between one or more services and other tools or databases.

In one or more embodiments, the server I/O interfaces 126 may be configured to enable wired and/or wireless communications. The server I/O interfaces 126 may be configured to communicate data between the server 102 and other user devices (i.e., the user devices 106), network devices (i.e., routers in the network 110), systems, or domain(s) via the network 110. For example, the server I/O interfaces 126 may comprise a WI-FI interface, a LAN interface, a WAN interface, a modem, a switch, or a router. The server processor 128 may be configured to send and receive data using the server I/O interfaces 126. The server I/O interfaces 126 may be configured to use any suitable type of communication protocol. In some embodiments, the server I/O interfaces 126 may be an admin console comprising a web browser-based or graphical user interface used to manage a middleware server domain via the server 102. A middleware server domain may be a logically related group of middleware server resources that managed as a unit. A middleware server domain may comprise the server 102 and one or more managed servers. The managed servers may be standalone devices and/or collected devices in the server cluster. The server cluster may be a group of managed servers that work together to provide scalability and higher availability for the services. In this regard, the services are developed and deployed as part of at least one domain. In other embodiments, one instance of the managed servers in the middleware server domain may be configured as the server 102. The server 102 provides a central point for managing and configure the managed servers and any of the one or more services.

The server processor 128 comprises one or more processors communicatively coupled to the server memory 130. The server processor 128 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 128 may be a programmable logic device, a microcontroller, a microprocessor, or any suitable combination of the preceding. The one or more server processor 128 are configured to process data and may be implemented in hardware or software executed by hardware. For example, the server processor 128 may be 8-bit, 16-bit, 32-bit, 64-bit or of any other suitable architecture. The server processor 128 may include an arithmetic logic unit (ALU) for performing arithmetic and logic operations, processor registers that supply operands to the ALU and store the results of ALU operations, and a control unit that fetches the instructions 132 from the server memory 130 and executes them by directing the coordinated operations of the ALU, registers and other components. In this regard, the one or more server processor 128 are configured to execute various instructions. For example, the one or more server processor 128 are configured to execute the instructions 132 to implement the functions disclosed herein, such as some or all of those described with respect to FIGS. 1-3B. In some embodiments, the functions described herein are implemented using logic units, FPGAs, ASICs, DSPs, or any other suitable hardware or electronic circuitry.

In one or more embodiments, the server I/O interfaces 126 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server I/O interfaces 126 may be configured to support any suitable type of communication protocol as would be appreciated by one of ordinary skill in the art. In one or more embodiments, the server I/O interfaces 126 may comprise one or more sensors configured to evaluate physical phenomena surrounding the server 102 and/or one or more of the user devices 106. The sensors may be proximity sensors, optical sensors, and the like.

The server memory 130 may be volatile or non-volatile and may comprise a read-only memory (ROM), random-access memory (RAM), ternary content-addressable memory (TCAM), dynamic random-access memory (DRAM), and static random-access memory (SRAM). The server memory 130 may be implemented using one or more disks, tape drives, solid-state drives, and/or the like. The server memory 130 is operable to store the instructions 132, the feedback data 104 comprising the one or more user devices performances 134 and the one or more interactions 136 associated to the one or more interaction types 138, the one or more tracking parameters 140, the input data 142 comprising the historical usage data 144 and the one or more documentations 146, the application information 148 comprising the at least one base code 150 with multiple code blocks 152 and multiple application portions 153, the one or more modifications 154, the one or more impacts 156 of the one or more code blocks 152 in the base code 150, the one or more release versions 158, the user information 160 comprising the one or more user profiles 162 associated with the one or more entitlements 164 to access the one or more services (e.g., applications), the one or more AI algorithms 166 configured to create the one or more models 168 through training operations, the one or more AI commands 170, and the one or more rules and policies 172.

The feedback data 104 may comprise information associated with one or more of the performances 134 associated with one or more portions 153 of a given application, information associated with one or more interactions 136 between one or more entities (e.g., the users 116) and one of the local applications 192, and one or more tracked activities associated with the entities. The feedback data 104 may comprise information provided by and/or obtained from the entities during one or more communication operations in the network 110. The server 102 may be configured to perform one or more retrieving operations configured to determine feedback data 104 in the tracked activities from the communication operations and generate one or more reports associated with interactions 136 of the entities in the network 110. The feedback data 104 may be collected continuously without interruptions and/or periodically over time and/or periods of time. The feedback data 104 may comprise one or more interactions 136 referencing one or more physical phenomena and/or aspects of a portion of one or more users 116. The feedback data 104 may be obtained via one or more models 168 configured with a natural language processing (NPL) that identifies conversations associated with one or more of the users 116. The feedback data 104 may be captured via the one or more server I/O interfaces 126 and/or the one or more device interfaces 182. The feedback data 104 may comprise multiple sound, text, and/or action data samples. Each data sample may comprise a magnitude and a duration. The feedback data 104 may be configured to reference one or more attempted actions associated with the communication operations.

The one or more communication operations may be one or more data exchanges performed between two or more network devices in the system 100. The network devices may comprise the server 102 and one or more of the user devices 106, among others. In one or more embodiments, the communication operations may be audio communications exchanged as part of audio conversations (e.g., during a telephonic call) between two or more network devices. The communication operations may be image and/or text communications exchanged as part of image-based conversations (e.g., during videocalls and/or chat exchanges) between two or more network devices.

The one or more communication operations may be one or more operations executed by the server processor 128 configured to enable data objects to be exchanged between the user devices 106 and/or the server 102. In one or more embodiments, the communication operations may be configured to indicate one or more data objects to be exchanged between the server 102 and at least one of the user devices 106. The server 102 may be configured to generate and analyze one or more communication operations to confirm whether one or more entities associated with communication operations are legitimately associated with at least one of the user devices 106. The server 102 may be configured to perform one or more operations in which the server 102 is configured to confirm whether one or more communication operations belong to a specific user device 106.

The feedback data 104 may indicate one or more changes in the behavior associated with one or more of the entities. In one or more embodiments, the interactions 136 are information data representative on one or more aspects of the communication operations performed and/or triggered by the one or more entities in the network 110. The interactions 136 may be data that represents extracted information and/or summarized information of the feedback data 104 associated with one or more operations attempted and/or performed by the entities. In the example of FIG. 1, the interactions 136 may be comprised in business metadata used by one of the applications and may be dynamic in nature. The interactions 136 may be individual aspects of the feedback data 104. For example, in feedback data 104 comprising an image manipulation in one of the local applications 192, the interactions 136 may be individual changes to pixels of the image comprising one or more data categorization formats and one or more data types.

The one or more interaction types 138 may be one or more representative of specific aspects of the feedback data 104 and/or the interactions 136. The interaction types 138 may be configured to indicate one or more data types associated with one or more interactions 136 between the user devices 106 and the local applications 192. The data types may indicate a source corresponding to specific feedback data 104. The data types may comprise one or more data identifiers associated for each interaction 136. The data types may be information specific for each interaction 136. For example, a first interaction 136 in feedback data 104 may comprise an interaction type 138 representing a specific use of a database in a local application 192 in a given user device 106. The data types may be formats of the data sets, times in which the data sets are accessed, or data sets sizes, among others. Each of the interaction types 138 may be associated with one or more of the data types.

In one or more embodiments, the interaction types 138 may be matched to specific communication types performed by the user devices 106, one or more specific changes in the user device 106 as a specific local application 192 performs one or more specific operations. In some embodiments, the interaction types 138 may comprise access to specific operations in the local application 192. For example, the interaction types 138 may comprise communications performed using short-range wireless communication capabilities, communications performed using long-range wireless communication capabilities, communications using encrypted services, and the like. The interaction types 138 and the interactions 136 may comprise multiple embodiments, such as changes in a user interface, changes in configurations of the local application 192, changes to communication packets and/or specific communication packets exchanges triggered while using the local application 192.

In one or more embodiments, the performances 134 may be associated with specific physical interfaces of the user devices 106 and/or specific portions 153 of the application. For example, the performances 134 may be tracked for specific operations performed in the application. The performances 134 may be collected, determined, and/or obtained using one or more tracking parameters 140. The performances 134 may be partial and/or absolute for one or more features of the application. For example, a performance 134 of the application may track processor consumption in user devices 106 as the application is used to trigger long-range data exchange operations. In another example, an overall performance 134 of the application may be tracked to determine an overall optimization of the application.

In one or more embodiments, the tracking parameters 140 may be one or more representations of physical phenomena in the suer devices 106. For example, the user devices 106 may comprise sensors that track cooling or heating in the user device 106. The server 102 may be configured to create one or more tracking parameters 140 to track one or more of the physical phenomena surrounding the user devices 106, content in displayed in screens of the user devices 106, and/or data throughput, processor speeds (e.g., CPU speeds), and/or memory usage during specific application operations. In another example, the tracked parameters may comprise a number of frames per second shown in a screen when the application transitions between operations, downloading speeds while retrieving data from a server, and the like.

In one or more embodiments, the input data 142 may be one or more data records and/or data elements used to train one or more of the AI algorithms 166. The historical usage data 144 may be historical data associated with previous usage of the application by one or more users 116 in one or more user devices 106. The documentations 146 may be any information associated with source code and/or previous release versions 158 of an application. In some embodiments, the server 102 may be configured to train one of more AI algorithms 166 using negative information in data elements and/or data records. Examples of negative information may comprise failed changes to the base code 150 that resulted in sub-optimal performance of the application in the user devices. In other embodiments, the server 102 may be configured to train one of more AI algorithms 166 using positive information in data elements and/or data records. Examples of positive information may comprise successful changes to the base code 150 that resulted in more optimal performance of the application in the user devices.

In one or more embodiments, the application information 148 may comprise one or more data elements and/or data records associated with the base code 150 of an application. The base code 150 may be code of a given release version 158 of a given application. The code blocks 152 may be one or more individual sections of the base code 150. The code blocks 152 may be electrically divided from the base code 150 using the trained AI algorithm 166. In some embodiments, the servers 102 may be configured to use the trained AI algorithm 166 to electronically divide the base code 150 into multiple code blocks 152 corresponding to specific features in portions 153 of the application. The portions 153 may be features of the application as provided in the user devices 106 and not in the base code 150.

In one or more embodiments, the modifications 154 may be one or more recommendations to change the base code 150 and/or individual code blocks 152 in the base code 150. The modifications 154 may be one or more suggested modifications 154 and/or one or more instructed modifications 154. The one or more suggested modifications 154 may be one or more modifications 154 to the base code 150 and/or specific code blocks 152 of the application that may be denied and/or accepted using further processing and/or analyses. The one or more instructed modifications 154 may be one or more modifications 154 to the base code 150 and/or specific code blocks 152 of the application that must be accepted as changes to the base code 150.

In one or more embodiments, the impacts 156 may be one or more evaluation results in which possible adversities and/or possible improvements are considered in relation with the use of the application by one or more of the user devices 106. In one or more embodiments, the release versions 158 may be different versions of the application released over time.

The user information 160 may comprise the one or more user profiles 162, one or more entitlements 164, and one or more services. In one or more embodiments, the user profiles 162 may comprise multiple profiles associated with one or more entitlements 164 to access and/or modify the services. Each of the user profiles 162 may be associated with one or more entitlements 164. The entitlements 164 may indicate that a given user device 106 is allowed to use features in a given application in accordance with the one or more rules and policies 172. The entitlements 164 may indicate that a given user device 106 is allowed to perform one or more operations in the system 100 (e.g., provide a specific application data access to one of the users 116). The entitlements 164 may be assigned to a given user profile 162 in accordance with updated security information, which may provide guidance parameters to the use of the entitlements 164 based at least upon corresponding rules and policies 172. In one or more embodiments, the one or more services perform one or more application operations using one or more access commands. In some embodiments, the user profiles 162 may comprise multiple profiles for the users 116. Each user profile 162 may comprise one or more entitlements 164. As described above, the entitlements 164 may indicate that a given user 116 is allowed to access one or more network resources in accordance with one or more rules and policies 172. The entitlements 164 may indicate that a given user 116 is allowed to perform one or more data exchanges with the server 102 via the network 110. In one or more embodiments, each of the user profiles 162 may comprise information about at least one user 116 entitled to trigger one or more communication operations 108.

In one or more embodiments, the AI algorithms 166 may be executed by the server processor 128 to evaluate the communication operations and/or the feedback data 104. Further, the AI algorithms 166 may be configured to interpret and transform one or more request for optimizing portions 153 in a given application, the one or more communication operations, the feedback data 104, and/or the instructions 132 into structured data sets and subsequently stored as files or tables. The AI algorithms 166 may cleanse, normalize raw data, and derive intermediate data to generate uniform data in terms of encoding, format, and data types. The AI algorithms 166 may be executed to run user queries and advanced analytical tools on the structured data and/or the unstructured data in accordance with one or more models 168. The AI algorithms 166 may be trained to generate the one or more AI commands 170 based on one or more results of multiple training operations. The AI commands 170 may be parameters that proactively trigger one or more of the training operations. The AI commands 170 may be combined with the existing instructions 132 to dynamically trigger and/or perform the training operations and/or some or all of the communication operations. The AI commands 170 may be configured to trigger one or more cognitive AI operations in accordance with one or more models 168. The models 168 may be generated by the one or more trained AI algorithms 166 based on historic information associated with any training operations performed with the server 102.

In one or more embodiments, the one or more training operations may comprise one or more operations executed in conjunction with the one or more operations of the AI algorithms 166. The one or more training operations may be configured to structure and analyze the feedback data 104, historical activity data in the form of the input data 142, the user information 160, the rules and policies 172, and/or one or more analysis results from the application information 148. The training operations may be configured to use some or all of the aforementioned data as input parameters to update, regulate, and/or modify the AI algorithm 166 and/or the one or more models 168. The one or more analysis results may be one or more results of one or more analyses performed by the server processor 128. The analyses may be performed as part of one or more operations triggered after executing the one or more instructions 132 (e.g., comprising executing the AI algorithm 166). The analysis results may be structured data comprising information in the form of lists, tables, and/or databases, among others.

The rules and policies 172 may be security configuration commands or regulatory operations predefined by an organization or one or more users 116. In one or more embodiments, the rules and policies 172 may be dynamically defined by the one or more users 116. The rules and policies 172 may be prioritization rules configured to instruct one or more user devices 106 to perform one or more evaluating operations or perform one or more operations in the system 100 in a specific communication operation. The one or more rules and policies 172 may be predetermined or dynamically assigned by a corresponding user 116 or an organization associated with the users 116.

In one or more embodiments, the server databases 124 may be one or more repositories configured to store information. In one example, the server 102 may determine the server processor 128 is available (e.g., running) to perform a specific service. In another example, the server 102 may determine that a specific managed server is running to enable a testing application and/or perform the specific service upon receiving a server response indicating that a corresponding managed server is available to perform the service. The server databases 124 may be configured to store one or more representations of data instead of storing coded data. In this regard, the representations may be encoded in accordance with an encoder configured to identify and/or verify exchanged information. For example, the server databases 124 may comprise one or more representations of the feedback data 104. As the feedback data 104 is obtained, the server processor 128 may be configured to process the feedback data 104 in accordance with the one or more aforementioned operations.

### User Device

In one or more embodiments, each of the user devices 106 (e.g., the user device 106a, the user device 106b and the user device 106g in the user device group 112a, and the user device 106d, the user device 106f, the user device 106h, and the user device 106i in the user device group 112a) may be any computing device configured to communicate with other devices, such as the server 102, other user devices 106 in the user device group 112, databases, and the like in the system 100. Each of the user devices 106 may be configured to perform specific functions described herein and interact with the server 102 and/or any other user devices 106. Examples of the user devices 106 comprise, but are not limited to, a laptop, a computer, a smartphone, a tablet, a smart device, an IoT device, a simulated reality device, an augmented reality device, or any other suitable type of device. The requests may be provided by the user devices 106 via one or more interfaces comprising input displays, voice microphones, or sensors capturing gestures performed by a corresponding user 116.

The user devices 106 may be hardware configured to create, transmit, and/or receive information. The user devices 106 may be configured as a provider node or as worker nodes. The user devices 106 may be configured to receive inputs from a user, process the inputs, and generate data information or command information in response. The data information may include documents or files generated using a graphical user interface (GUI).

Referring to the user device 106a as a non-limiting example, the command information may include input selections/commands triggered by a user using a peripheral component or one or more device peripherals 184 (i.e., a keyboard) or an integrated input system (i.e., a touchscreen displaying the GUI). The user devices 106 may be communicatively coupled to the server 102 via a network connection (i.e., the device peripherals 184). The user devices 106 may transmit and receive data information, command information, or a combination of both to and from the server 102 via the device interfaces 182. In one or more embodiments, the user devices 106 are configured to exchange data, commands, and signaling with the server 102. In some embodiments, the user devices 106 are configured to receive at least one security system configuration from the server 102 to implement a security system (one of the one or more local applications 192) at one of the user devices 106.

In one or more embodiments, the device interfaces 182 may be any suitable hardware or software (e.g., executed by hardware) to facilitate any suitable type of communication in wireless or wired connections. These connections may comprise, but not be limited to, all or a portion of network connections coupled to additional user devices 106, the server 102, the Internet, an Intranet, a private network, a public network, a peer-to-peer network, the public switched telephone network, a cellular network, a LAN, a MAN, a WAN, and a satellite network. The device interfaces 182 may be configured to support any suitable type of communication protocol.

In one or more embodiments, the one or more device peripherals 184 may comprise audio devices (e.g., speaker, microphones, and the like), input devices (e.g., keyboard, mouse, and the like), or any suitable electronic component that may provide a modifying or triggering input to the user devices 106. For example, the one or more device peripherals 184 may be speakers configured to release audio signals (e.g., voice signals or commands) during media playback operations. In another example, the one or more device peripherals 184 may be microphones configured to capture audio signals. In one or more embodiments, the one or more device peripherals 184 may be configured to operate continuously, at predetermined time periods or intervals, or on-demand.

The device processor 186 may comprise one or more processors communicatively coupled to and in signal communication with the device interfaces 182, the device peripherals 184, and the device memory 188. The device processor 186 is any electronic circuitry, including, but not limited to, state machines, one or more CPU chips, logic units, cores (e.g., a multi-core processor), FPGAs, ASICs, or DSPs. The device processor 186 may be a programmable logic device, a microcontroller, a microprocessor, or any suitable combination of the preceding. The one or more processors in the device processor 186 are configured to process data and may be implemented in hardware or software executed by hardware. For example, the device processor 186 may be an 8-bit, a 16-bit, a 32-bit, a 64-bit, or any other suitable architecture. The device processor 186 may comprise an ALU to perform arithmetic and logic operations, processor registers that supply operands to the ALU, and store the results of ALU operations, and a control unit that fetches software instructions such as device instructions 190 from the device memory 188 and executes the device instructions 190 by directing the coordinated operations of the ALU, registers, and other components via a device processing engine (not shown). The device processor 186 may be configured to execute various instructions.

The device memory 188 may comprise multiple operation data and one or more local applications 192 associated with the server 102. The operation data may be data configured to enable one or more data processing operations such as those described in relation with the server 102. The operation data may be partially or completely different from those comprised in the server memory 130. The local applications 192 may be one or more of the services described in relation with the server 102. In some embodiments, the local applications 192 may be partially or completely different from those comprised in the server memory 130.

In one or more embodiments, the server 102 is configured to perform one or more of code modification operations in one of the local applications 192. Herein, the server 102 may be configured to perform one or more code modification operations based on the interactions 136 captured in feedback data 104 received in a given interaction 136 captured in a corresponding user device 106. The interactions 136 may comprise one or more interaction types 138.

### Network

The network 110 facilitates communication between and amongst the various devices of the system 100. The network 110 may be any suitable network operable to facilitate communication between the server 102 and the user devices 106 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Operational Flow to Dynamically Modify Specific Code Portions of an Application

FIG. 2 shows an operational flow 200 in which the system 100 of FIG. 1 is configured to dynamically modify specific code portions of an application, in accordance with one or more embodiments. In FIG. 2, the operational flow 200 comprise multiple operations in the communication network. The operational flow 200 may be performed between the server 102 and one or more electronic devices to determine whether certain entities are associated with one of more of the user devices 106. The operational flow 200 comprise collected feedback data 202 from user devices 106a-106g. The server 102 may comprise a release manager 204, a software variant monitoring system 206, at least one secured database 208, a code augmentation system 210, a document enhancer 212, and a developer's platform 214. The operational flow 200 may comprise operations 220-296 performed by the server 102 and/or one or more user devices.

In one or more embodiments, the server I/O interfaces 126 and/or the device interfaces 182 may be configured to provide collected feedback data 202 from the user devices 106a-106g. The collected feedback data 202 may be feedback data 104 collected from the user devices 106a-106g. For example, feedback data 104 may be collected from a screen in the user device 106. In another example, feedback data 104 may be collected from antenna usage and power consumption during wireless communications in the user device 106.

In one or more embodiments, the collected feedback data 202 is provided to the release manager 204. At the release manager 204, the server 102 may be configured to perform operations 220-234. At operation 220, the server 102 may be configured to electronically extract intelligent interaction behavior from the collected feedback data 202. Herein, the server 102 may be configured to use a trained AI algorithm 166 to identify patterns in the collected feedback data 202 and determine any intentions associated with any determined interactions 136 based on expected usage of an application. At operation 222, the server may be configured to use historical metadata (e.g., historical usage data 144) associated with the users 106a-106g as input data 142 for one or more eligibility checks performed at operation 232. At operation 234, the server 102 may be configured to perform one or more feature facet lookup in which filtering parameters are generated. The filtering parameters may be used to guide one or more lexical searches performed to distinguish repeated interactions 136 in the collected feedback data 202. At operation 232, the server 102 may be configured to check for modification eligibility in the base code 105 of an application based on the historical metadata obtained at operation 222 and the filtering parameters provided at the operation 234. At operation 232, the server 102 may be configured to determine one or more repeated interactions 136 between the user devices 106a-106g and a same application hosted in these devices.

In some embodiments, the server 102 may be configured to determine whether a repeated interaction 136 is approved for consideration to create a new release version 158 of the application. At operation 240, the server 102 may be configured to determine whether the repeated interaction 136 is approved to be evaluated for creation of the new release version 158 of the application. A difference between the operation 232 and the operation 240 is that the server 102—at operation 232—evaluates whether a specific interaction 136 is repeated a predefined number of times and—at operation 240—evaluates whether the specific interaction 136 is relevant to merit a change to the base code 150 of the application. For example, an interaction 136 comprising connecting to public networks may be determined at the operation 232 to be commonly used by the user devices 106a-106g. In this example, at operation 240, the server 102 may determine whether connectivity to public networks justifies creation of a new release version 158 of the application. Herein, a new release version 158 focused in connectivity to public networks may not be justified if a current release version 158 of the application already optimizes this type of connectivity.

If the interaction 136 is considered to be pilot eligible (e.g., YES), the operational flow 200 proceeds to the software variance system 206 where the server is configured to perform operations 242-248. If the interaction 136 is considered to not be pilot eligible (e.g., NO), the operational flow 200 proceeds to a fallback mechanism at operation 252. In one or more operations, the fallback mechanism comprises dropping the operational flow 200 and wait for a predefined period of time until feedback data 104 is collected again.

In the software variant monitoring system 206, the server 102 may be configured to use a trained AI algorithm 166 to determine whether the specific interaction 136 is optimizable in a specific portion 153 of the application. At operation 242, the server 102 may be configured to obtain any information associated with the portion 153 where the interaction 136 is found. At operation 244, the server 102 is configured to electronically extract features from the base code 150 of the application. At operation 246, the server 102 may be configured to evaluate usage of the features found in the base code 150. At operation 248, the portion 153 in which the interaction 136 is determined is evaluated for possible regulations or optimization guidance as provided by one or more AI commands 170 and/or one or more rules and policies 172. After the interaction 136 is approved for further analysis, the server 102 is configured to provide the possible regulations or optimization guidance to the code augmentation system 210. Further, the software variant monitoring system 206 is configured to attach an impact 156 associated with optimization of the interaction 136 in the base code 150 of the application.

In one or more embodiments, the code augmentation system 210 may be configured to use a trained AI algorithm 166 to collect, process, and improve individual portions 153 of an application by modifying one or more corresponding code blocks 152 in the base code 150 of the application. Herein, the server is configured to perform operations 280-290. At operation 280, the server 102 may be configured to u8se one or more cloud systems to preserve (e.g., store) one or more portions 153 of the application. At operation 282, the server 102 may be configured to identify different elements in the portions 153. At operation 284, the server 102 is configured to derive multiple templates of the application in which the multiple portions 153 are mapped. These templates may be used to inform one or more of the lexical searches performed by the server 102 at the release manager 204.

At operation 286, the server 102 is configured to consider one or more mapping commands in which the base code 150 is electronically divided into multiple code blocks 152. The code blocks 152 configured to include multiple elements from the base code 150 that are related in accordance with one or more functionalities of the application and/or a portion 153 of the application. At operation 288, the server 102 is configured to annotate the base code 150 to identify specific elements and/or operations triggered in the application. At operation 290, the server 102 is configured to actively improve embedding of comments and/or commands in the code blocks 152 in the base code 150. At operation 292, the server 102 may be configured to determine a possible change between the base code 150 and an updated version of the base code 150. Herein, the server 102 may be configured to generate a possible impact 156 caused to the base code 150 caused by one or more possible modifications 154. At operation 294, the server 102 is configured to train an AI algorithm 166using multiple documentation 146 relating to source code of the application and previous changes, modifications, and/or improvements implemented in the base code 150. At operation 296, the server 102 may be configured to use the annotated base code 150 from the operation 288, the embedded code designs from the operation 290, the impacts 156 from the operation 292 and the insights provided by the AI algorithm 166 trained at the operation 294 to generate understanding of the base code 150 in a language understanding model. Herein, the server 102 is configured to use information available with a source code of the application and the base code 150 to generate an understanding of the base code 150 in plain English.

In one or more embodiments, contrary to conventional systems that require operators to undergo lengthy review processes to understand elements used in base code 150 of applications, the server 102 may be configured to provide a communication matrix to operators that allows modifications to the code base of applications using natural language commands (e.g., using sentences in plain English). For example, an operator looking to improve communication between a user device 105 hosting the application and specific servers of an organization may state in the communication matrix instructions to improve connectivity in specific communication channels. Herein, the system may be configured to understand the plain English request, generate a solution in which the connectivity is improved, and modify specific portions 153 of the base code 150 to implement the solution. In order to provide a communication matrix capable of receiving plain English commands as inputs, the server 102 may be configured to train artificial intelligence algorithms 166 to understand the base code 150 and any relations between elements in the code in plain English. Further, the server 102 may be configured to equip the communication matrix with a generated artificial intelligence model (e.g., one of the models 168) configured to electronically breakdown natural language commands received as inputs and determine an intent behind individual portions of the commands. Based on the determined intent, the server 102 may be configured to tag elements of the base code 150 to be modified to achieve the intent and implement changes to the base code 150 that achieve a desired modification. The artificial intelligence models may be achieved by training the artificial intelligence algorithms 166 to pre-process all documentation associated with the source code of an application, changes to the source code over the life of the application, and the current base code 150 of the application. During training, the artificial intelligence algorithms 166 may develop understanding for current status of elements called out in the base code 150 and failed elements previously introduced to the source code. The failed elements may be individual code lines that are now retired from the base code 150 and documented reasons for making said modifications.

At operation 254, the server 102 may be configured to determine whether the expected usage of a new release version 158 of the application comprises a foreseeable usage. Herein, the software variant monitoring system 206 may be configured to determine possible usage of an optimized version of the application in which the interaction 136 is prioritized. The usage may be assigned a value and that value may be compared to a preset threshold. If the usage value is determined to be less than the threshold (e.g., YES), the server 102 may be configured to determine that optimizing the application to improve access and/or performance of the interaction 136 is useful. At this stage, the operational flow 200 proceeds to the document enhancer 212 where the server 102 is configured to perform operations 260 and 262. If the usage value is not determined to be less than the threshold (e.g., NO), the server 102 may be configured to determine that optimizing the application to improve access and/or performance of the interaction 136 is not useful. At this stage, the operational flow 200 proceeds to a fallback mechanism at operation 252. In one or more operations, the fallback mechanism comprises dropping the operational flow 200 and wait for a predefined period of time until feedback data 104 is collected again.

In some embodiments, the server 102 is configured to enhance the contents of the documentations 146 via the document enhancer. At operation 260, the server 102 is configured to design a delta vector that symbolizes the change to the base code 150. At operation 262, the server 102 is configured to add the design delta vector to the documentations 146.

At the developer's platform, the server 102 is configured to perform operations 270 and 272. At operation 272, the server 102 is configured to use automated regression testing of modified portions of the base code 150. At operation 270, the server 102 is configured to update one or more individual code blocks 152 in the base code 150 in plain language. In one or more embodiments, the server 102 may be configured to store one or more communication elements, inputs, and/or outputs in the secured database 208. The secured database 208 may be one or more of the server databases 124.

In one or more embodiments, the operational flow 200 leverages customized cloud and generative AI to have an “n” number of variations of software and roll out to specific release versions 158 of the software at a same time. The release versions 158 may be adapted for specific needs of at least a segment 113 of the user devices 106. In some embodiments, the operational flow 200 comprises rolling out “n” variations of software and selection of the best software version of an application. Further, the operational flow 200 is configured to process information related to the base code 150 and augment existing code by either enhancing or removing particular functions and/or rules based on the information received from the developer's platform 214. The operational flow 200 is configured to inhibit and/or eliminate the need for multiple pilot/rollout schedules and support releases, by having software adapt to customer needs and customer segment affiliation with software versions. In some embodiments, the code augmentation system 210 is configured to help and improve developer experience by scaling rolled out feature performance and/or customer interactions 136 with a new feature, via a decision score generated using the developer's platform 214.

### Example Process to Dynamically Modify Specific Code Portions of an Application

FIGS. 3A and 3B illustrate an example flowchart of a process 300 configured to dynamically modify specific code portions of an application (e.g., one of the local applications 192 via the application information 148), in accordance with one or more embodiments. Modifications, additions, or omissions may be made to the process 300. The process 300 may comprise more, fewer, or other operations than those shown in FIGS. 3A and 3B. For example, operations may be performed in parallel or in any suitable order. While at times discussed as the server 102, the user devices 106, or components of any of thereof performing operations described in operations 302-348 in the process 300, any suitable system or components of the system 100 may perform one or more operations of the process 300. For example, one or more operations of the process 300 may be implemented, at least in part, in the form of instructions 132 of FIG. 1, stored on non-transitory, tangible, machine-readable media (e.g., a non-transitory computer-readable medium such as server memory 130 of FIG. 1) that when run by one or more processors (e.g., the processor 128 of FIG. 1) may cause the one or more processors to perform operations described in operations 302-348.

The process 300 starts at operation 302, where the server 102 is configured to collect usage data from a plurality of user devices 106 in a user device group 112. In some embodiments, collected feedback data 202 may be collected periodically and/or continuously over time. At operation 304, the server 102 is configured to determine whether the user devices 106 in the user device group 112 comprise the latest application release (e.g., latest release versions 158). The server 102 may be configured to determine one or more identifiers associated with a current release version 158 in the user devices 106. The server 102 may be configured to determine whether the identifier matches one or more of the release versions 158 stored in the memory.

At operation 310, the server 102 is configured to indicate whether the user devices 106 in the user device group 112 comprise the latest application release. If the server 102 determines that the user devices 106 in the user device group 112 do not comprise the latest application release (e.g., NO), the process 300 proceeds to operation 312. If the current release version 158 of the local applications 192 in the user devices 106 does not match a latest release version 158 stored in the server memory 130, the server 102 is configured to determine that ta current release version 158 of the local applications 192 in the user devices 106 is not up to date. If the server 102 determines that the user devices 106 in the user device group 112 comprise the latest application release (e.g., YES), the process 300 proceeds to operation 322. If the current release version 158 of the local applications 192 in the user devices 106 matches a latest release version 158 stored in the server memory 130, the server 102 is configured to determine that ta current release version 158 of the local applications 192 in the user devices 106 is up to date.

At operation 312, the server 102 is configured to trigger a maintenance window for the user devices 106. The maintenance window may be one or more periods of time in which operations in the local applications 192 may be paused, stopped, and/or delayed. The maintenance window may have a predetermined duration and/or a dynamically modified duration. At operation 314, the server 102 is configured to replace, during the maintenance window, a current version of the application in the user devices 106 with the latest application release. At operation 316, the server 102 is configured to close the maintenance window for the user devices 106.

At operation 322, the server 102 may be configured to train a first artificial intelligence algorithm 166 based on first input data 142 representative of historical usage data 144 of an application. The historical usage data 144 may comprising usage patterns associated with a portion 153 of the local application 192. At operation 324, the server 102 is configured to create tracking parameters 140 configured to track performance 134 of a portion 153 of the application. The server 102 may be configured to create, using the trained first artificial intelligence algorithm 166, the tracking parameters 140. At operation 326, track, in conjunction with the tracking parameters 140, interactions between a user device group 112 and the portion 153 of the application. At operation 328, the server 102 is configured to structure the interactions 136 into one or more interaction types 138. The server 102 may be configured to structure, using the trained first artificial intelligence algorithm 166, the interactions 136 into one or more interaction types 138. At operation 330, the server 102 is configured to associate a first interaction type 138 of the one or more interaction types 138 with a segment 113 of user devices 106 of the user device group 112. At operation 332, the server 102 is configured to train a second artificial intelligence algorithm 166 based on second input data 142 representative of documentation 146 associated with base code 150 of the application. The server 102 may be configured to train a second artificial intelligence algorithm 166 based at least in part upon second input data 142 representative of documentation 146 associated with base code 150 of the local application 192. The documentation 146 may comprise compilation reports associated with previous updates of the local application 192 and the base code 150. The base code 150 may be representative of a current release version 158 of the local application 192. At operation 334, the server 102 is configured to electronically divide the base code 150 into code blocks 152 based at least in part upon a corresponding impact 156 of each code block 152 in the base code 150 of the application. The server 102 may be configured to electronically divide, using the trained second artificial intelligence algorithm 166, the base code 150 into multiple code blocks 152 based at least in part upon a corresponding impact 156 of each code block 152 in the base code 150 of the local application 192. At operation 336, the server 102 is configured to correlate an impact 156 of a code block to the portion 153 of the application. The server 102 may be configured to correlate, using the trained second artificial intelligence algorithm 166, the impact 156 of the specific code block 152 to the portion 153 of the local application 192.

The process 300 may continue at operation 338, where the server 102 is configured to electronically extract the code block 152. The server 102 may be configured to electronically extract, using the trained second artificial intelligence algorithm 166, the specific code block 152. At operation 340, the server 102 is configured to determine a modification 154 to the code block 152 based on the interaction type 138 and the impact 156 of the code block 152 to the portion 153 of the application. The server 102 may be configured to determine, using the trained second artificial intelligence algorithm 166, a modification 154 to the specific code block 152 based at least in part upon the interaction type 138 of the one or more interaction types 138 and the impact 156 of the code block 152 to the portion 153 of the local application 192. The modification 154 to the specific code block 152 may be configured to prioritize performance 134 of the interaction type 138 when performed in the portion 153 of the local application 192. At operation 342, the server 102 is configured to modify the code block 152 to include the modification 154. The server 102 may be configured to modify, using the trained second artificial intelligence algorithm 166, the specific code block 152 to include the modification 154. At operation 344, the server 102 is configured to compile a modified version of the code block 152. The server 102 may be configured to compile, using the trained second artificial intelligence algorithm 166, a modified version of the specific code block 152. At operation 346, the server 102 is configured to incorporate the modified version of the code block 152 back into an updated version of the base code 150. The server 102 may be configured to incorporate, using the trained second artificial intelligence algorithm 166, the modified version of the specific code block 152 back into an updated version of the base code 150.

The process 300 may end at operation 348, where the server 102 may be configured to release the updated version of the base code 150 as a new release version 158 of the application to the segment 113 of user devices 106 of the user device group 112. The server 102 may be configured to release, using the trained first artificial intelligence algorithm 166, the updated version of the base code 150 as a new release version 158 of the local application 192 to the segment 113 of user devices 106 of the user device group 112. The new release version 158 of the local application 192 may be configured to prioritize performance 134 of the interaction type 138 when performed in the portion 153 of the local application 192 by the segment 113 of user devices 106 of the user device group 112.

In some embodiments, the new release version 158 of the local application 192 may be released to the segment 113 of user devices 106 during a maintenance window. The new release version 158 of the local application 192 may be released to the segment 113 of user devices 106 outside of a maintenance window. Further, the interactions 136 between the user device group 112 and the portion 153 of the local application 192 are associated with positive feedback provided by the user devices 106 in the user device group 112. In other embodiments, the interactions 136 between the user device group 112 and the portion 153 of the local application 192 may be associated with negative feedback provided by the user devices 106 in the user device group 112.

In one or more embodiments, the server 102 may be configured to track, using the plurality of tracking parameters 140, multiple interactions 136 between the user device group 112 and the new release version 158 of the local application 192 over a period of time. Further, the server 102 may be configured to calculate, using the trained first artificial intelligence algorithm 166, an overall performance 134 of the new release version 158 of the local application 192. In some embodiments, the server 102 may be configured to generate multiple releases of a same local application 192 for a same segment 113 over multiple periods of time. Over each time period, an overall performance 134 of a specific modified portion 153 of local application 192. After a preset number of updated release versions targeting a same optimization are evaluated, the server 102 may be configured to determine a version that caused the best overall performance 134 for permanent use in the segment 113.

Consistent with the above, in some embodiments, the server 102 may be configured to track, using the tracking parameters 140, additional interactions between the user device group 112 and an additional new release version 158 of the local application 192 over an additional period of time. The server 102 may be configured to calculate, using the trained first artificial intelligence algorithm 166, an overall performance 134 of the additional new release version 158 of the local application 192. The server 102 may be configured to compare, using the trained first artificial intelligence algorithm 166, the additional overall performance 134 of the additional new release version 158 of the local application 192 to the overall performance 134 of the first new release version 158 of the local application 192. At this stage, the server 102 may be configured to determine, using the trained first artificial intelligence algorithm 166, whether the additional overall performance 134 of the new release version 158 of the local application 192 is greater than the overall performance of the first new release version of the local application 192. In response to determining that the overall performance 134 of the additional new release version 158 of the local application 192 is greater than the first new release version 158 of the local application 192, the server 102 is configured to release, using the trained first artificial intelligence algorithm 166, the additional new release version 158 of the local application 192 as a permanent version of the local application 192 to the segment 113 of user devices 106 of the user device group 112. In other embodiments, in response to determining that the additional overall performance 134 of the additional new release version 158 of the local application 192 is not greater than the first new release version 158 of the local application 192, the server 102 is configured to release, using the trained first artificial intelligence algorithm 166, the first new release version 158 of the local application 192 as a permanent version of the local application 192 to the segment 113 of user devices 106 of the user device group 1112.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory operable to store:
one or more artificial intelligence algorithms configured to evaluate data; and at least one processor communicatively coupled to the memory and configured to:
train a first artificial intelligence algorithm based at least in part upon first input data representative of historical usage data of an application, the historical usage data comprising usage patterns associated with a portion of the application;
create, using the trained first artificial intelligence algorithm, a plurality of tracking parameters configured to track performance of the portion of the application;
track, in conjunction with the plurality of tracking parameters, a plurality of interactions between a user device group and the portion of the application;
structure, using the trained first artificial intelligence algorithm, the plurality of interactions into one or more interaction types;
associate a first interaction type of the one or more interaction types with a segment of user devices of the user device group;
train a second artificial intelligence algorithm based at least in part upon second input data representative of documentation associated with base code of the application, wherein:
the documentation comprising compilation reports associated with previous updates of the application and the base code; and
the base code being representative of a current release version of the application;
electronically divide, using the trained second artificial intelligence algorithm, the base code into a plurality of code blocks based at least in part upon a corresponding impact of each code block in the base code of the application;
correlate, using the trained second artificial intelligence algorithm, an impact of a code block to the portion of the application;
electronically extract, using the trained second artificial intelligence algorithm, the code block from the plurality of code blocks;
determine, using the trained second artificial intelligence algorithm, a first modification to the code block based at least in part upon the first interaction type of the one or more interaction types and the impact of the code block to the portion of the application, the first modification to the code block being configured to prioritize performance of the first interaction type when performed in the portion of the application;
modify, using the trained second artificial intelligence algorithm, the code block to include the first modification;
compile, using the trained second artificial intelligence algorithm, a first modified version of the code block;
in response to compiling the first modified version of the code block, incorporate, using the trained second artificial intelligence algorithm, the first modified version of the code block back into a first updated version of the base code; and
release, using the trained first artificial intelligence algorithm, the first updated version of the base code as a first new release version of the application to the segment of user devices of the user device group, wherein the first new release version of the application is configured to prioritize performance of the first interaction type when performed in the portion of the application by the segment of user devices of the user device group.

2. The system of claim 1, wherein:
the first new release version of the application is released to the segment of user devices during a maintenance window.

3. The system of claim 1, wherein:
the plurality of interactions between the user device group and the portion of the application are associated with positive feedback provided by a plurality of user devices in the user device group.

4. The system of claim 1, wherein:
the plurality of interactions between the user device group and the portion of the application are associated with negative feedback provided by a plurality of user devices in the user device group.

5. The system of claim 1, wherein the at least one processor is further configured to:
track, using the plurality of tracking parameters, a first additional plurality of interactions between the user device group and the first new release version of the application over a first period of time; and
calculate, using the trained first artificial intelligence algorithm, an overall performance of the first new release version of the application.

6. The system of claim 5, wherein the at least one processor is further configured to:
associate a second interaction type of the one or more interaction types with the segment of user devices of the user device group;
electronically extract, using the trained second artificial intelligence algorithm, the code block from the plurality of code blocks;
determine, using the trained second artificial intelligence algorithm, a second modification to the code block based at least in part upon the second interaction type of the one or more interaction types and the impact of the code block to the portion of the application, the second modification to the code block being configured to prioritize performance of the second interaction type when performed in the portion of the application;
modify, using the trained second artificial intelligence algorithm, the code block to include the second modification;
compile, using the trained second artificial intelligence algorithm, a second modified version of the code block;
in response to compiling the second modified version of the code block, incorporate, using the trained second artificial intelligence algorithm, the second modified version of the code block back into a second updated version of the base code; and
release, using the trained first artificial intelligence algorithm, the second updated version of the base code as a second new release version of the application to the segment of user devices of the user device group.

7. The system of claim 6, the at least one processor is further configured to:
track, using the plurality of tracking parameters, a second additional plurality of interactions between the user device group and the second new release version of the application over a second period of time;
calculate, using the trained first artificial intelligence algorithm, an overall performance of the second new release version of the application;
compare, using the trained first artificial intelligence algorithm, the overall performance of the second new release version of the application to the overall performance of the first new release version of the application;
determine, using the trained first artificial intelligence algorithm, whether the overall performance of the second new release version of the application is greater than the overall performance of the first new release version of the application; and
in response to determining that the overall performance of the second new release version of the application is greater than the first new release version of the application, release, using the trained first artificial intelligence algorithm, the second new release version of the application as a permanent version of the application to the segment of user devices of the user device group.

8. The system of claim 6, the at least one processor is further configured to:
track, using the plurality of tracking parameters, a second additional plurality of interactions between the user device group and the second new release version of the application over a second period of time;
calculate, using the trained first artificial intelligence algorithm, an overall performance of the second new release version of the application;
compare, using the trained first artificial intelligence algorithm, the overall performance of the second new release version of the application to the overall performance of the first new release version of the application;
determine, using the trained first artificial intelligence algorithm, whether the overall performance of the second new release version of the application is greater than the overall performance of the first new release version of the application; and
in response to determining that the overall performance of the second new release version of the application is not greater than the first new release version of the application, release, using the trained first artificial intelligence algorithm, the first new release version of the application as a permanent version of the application to the segment of user devices of the user device group.

9. A method, comprising:
training a first artificial intelligence algorithm based at least in part upon first input data representative of historical usage data of an application, the historical usage data comprising usage patterns associated with a portion of the application;
creating, using the trained first artificial intelligence algorithm, a plurality of tracking parameters configured to track performance of the portion of the application;
tracking, in conjunction with the plurality of tracking parameters, a plurality of interactions between a user device group and the portion of the application;
structuring, using the trained first artificial intelligence algorithm, the plurality of interactions into one or more interaction types;
associating a first interaction type of the one or more interaction types with a segment of user devices of the user device group;
training a second artificial intelligence algorithm based at least in part upon second input data representative of documentation associated with base code of the application, wherein:
the documentation comprising compilation reports associated with previous updates of the application and the base code; and
the base code being representative of a current release version of the application;
electronically dividing, using the trained second artificial intelligence algorithm, the base code into a plurality of code blocks based at least in part upon a corresponding impact of each code block in the base code of the application;
correlating, using the trained second artificial intelligence algorithm, an impact of a code block to the portion of the application;
electronically extracting, using the trained second artificial intelligence algorithm, the code block from the plurality of code blocks;
determining, using the trained second artificial intelligence algorithm, a first modification to the code block based at least in part upon the first interaction type of the one or more interaction types and the impact of the code block to the portion of the application, the first modification to the code block being configured to prioritize performance of the first interaction type when performed in the portion of the application;
modifying, using the trained second artificial intelligence algorithm, the code block to include the first modification;
compiling, using the trained second artificial intelligence algorithm, a first modified version of the code block;
in response to compiling the first modified version of the code block, incorporating, using the trained second artificial intelligence algorithm, the first modified version of the code block back into a first updated version of the base code; and
releasing, using the trained first artificial intelligence algorithm, the first updated version of the base code as a first new release version of the application to the segment of user devices of the user device group, wherein the first new release version of the application is configured to prioritize performance of the first interaction type when performed in the portion of the application by the segment of user devices of the user device group.

10. The method of claim 9, wherein:
the first new release version of the application is released to the segment of user devices during a maintenance window.

11. The method of claim 9, wherein:
the plurality of interactions between the user device group and the portion of the application are associated with positive feedback provided by a plurality of user devices in the user device group.

12. The method of claim 9, wherein:
the plurality of interactions between the user device group and the portion of the application are associated with negative feedback provided by a plurality of user devices in the user device group.

13. The method of claim 9, further comprising:
tracking, using the plurality of tracking parameters, a first additional plurality of interactions between the user device group and the first new release version of the application over a first period of time; and
calculating, using the trained first artificial intelligence algorithm, an overall performance of the first new release version of the application.

14. The method of claim 13, further comprising:
associating a second interaction type of the one or more interaction types with the segment of user devices of the user device group;
electronically extracting, using the trained second artificial intelligence algorithm, the code block from the plurality of code blocks;
determining, using the trained second artificial intelligence algorithm, a second modification to the code block based at least in part upon the second interaction type of the one or more interaction types and the impact of the code block to the portion of the application, the second modification to the code block being configured to prioritize performance of the second interaction type when performed in the portion of the application;
modifying, using the trained second artificial intelligence algorithm, the code block to include the second modification;
compiling, using the trained second artificial intelligence algorithm, a second modified version of the code block;
in response to compiling the second modified version of the code block, incorporating, using the trained second artificial intelligence algorithm, the second modified version of the code block back into a second updated version of the base code; and
releasing, using the trained first artificial intelligence algorithm, the second updated version of the base code as a second new release version of the application to the segment of user devices of the user device group.

15. A non-transitory computer-readable medium storing instructions that when executed by a processor cause the processor to:
train a first artificial intelligence algorithm based at least in part upon first input data representative of historical usage data of an application, the historical usage data comprising usage patterns associated with a portion of the application;
create, using the trained first artificial intelligence algorithm, a plurality of tracking parameters configured to track performance of the portion of the application;
track, in conjunction with the plurality of tracking parameters, a plurality of interactions between a user device group and the portion of the application;
structure, using the trained first artificial intelligence algorithm, the plurality of interactions into one or more interaction types;
associate a first interaction type of the one or more interaction types with a segment of user devices of the user device group;
train a second artificial intelligence algorithm based at least in part upon second input data representative of documentation associated with base code of the application, wherein:
the documentation comprising compilation reports associated with previous updates of the application and the base code; and
the base code being representative of a current release version of the application;
electronically divide, using the trained second artificial intelligence algorithm, the base code into a plurality of code blocks based at least in part upon a corresponding impact of each code block in the base code of the application;
correlate, using the trained second artificial intelligence algorithm, an impact of a code block to the portion of the application;
electronically extract, using the trained second artificial intelligence algorithm, the code block from the plurality of code blocks;
determine, using the trained second artificial intelligence algorithm, a first modification to the code block based at least in part upon the first interaction type of the one or more interaction types and the impact of the code block to the portion of the application, the first modification to the code block being configured to prioritize performance of the first interaction type when performed in the portion of the application;
modify, using the trained second artificial intelligence algorithm, the code block to include the first modification;
compile, using the trained second artificial intelligence algorithm, a first modified version of the code block;
in response to compiling the first modified version of the code block, incorporate, using the trained second artificial intelligence algorithm, the first modified version of the code block back into a first updated version of the base code; and
release, using the trained first artificial intelligence algorithm, the first updated version of the base code as a first new release version of the application to the segment of user devices of the user device group, wherein the first new release version of the application is configured to prioritize performance of the first interaction type when performed in the portion of the application by the segment of user devices of the user device group.

16. The non-transitory computer-readable medium of claim 15, wherein:
the first new release version of the application is released to the segment of user devices during a maintenance window.

17. The non-transitory computer-readable medium of claim 15, wherein:
the plurality of interactions between the user device group and the portion of the application are associated with positive feedback provided by a plurality of user devices in the user device group.

18. The non-transitory computer-readable medium of claim 15, wherein:
the plurality of interactions between the user device group and the portion of the application are associated with negative feedback provided by a plurality of user devices in the user device group.

19. The non-transitory computer-readable medium of claim 15, wherein, when executed by the processor, the instructions further cause the processor to:
track, using the plurality of tracking parameters, a first additional plurality of interactions between the user device group and the first new release version of the application over a first period of time; and
calculate, using the trained first artificial intelligence algorithm, an overall performance of the first new release version of the application.

20. The non-transitory computer-readable medium of claim 19, wherein, when executed by the processor, the instructions further cause the processor to:
associate a second interaction type of the one or more interaction types with the segment of user devices of the user device group;
electronically extract, using the trained second artificial intelligence algorithm, the code block from the plurality of code blocks;
determine, using the trained second artificial intelligence algorithm, a second modification to the code block based at least in part upon the second interaction type of the one or more interaction types and the impact of the code block to the portion of the application, the second modification to the code block being configured to prioritize performance of the second interaction type when performed in the portion of the application;
modify, using the trained second artificial intelligence algorithm, the code block to include the second modification;
compile, using the trained second artificial intelligence algorithm, a second modified version of the code block;
in response to compiling the second modified version of the code block, incorporate, using the trained second artificial intelligence algorithm, the second modified version of the code block back into a second updated version of the base code; and
release, using the trained first artificial intelligence algorithm, the second updated version of the base code as a second new release version of the application to the segment of user devices of the user device group.
